(19) United States
(12) Patent Application Publication
(10) Pub. No.: US 2002/0164975 A1
(43) Pub. Date: Nov. 7, 2002

(54) Wireless message infoming system

(76) Inventor: Kun-Shan Lu, Taipei (TW)

Correspondence Address: RABIN & CHAMPAGNE, PC, 1101 14TH STREET, NW, SUITE 500, WASHINGTON, DC, 20005, US

(21) Appl. No.: 09/935,797

(22) Filed: Aug. 24, 2001

(30) Foreign Application Priority Data
May 1, 2001 (TW) 90110445

(51) Int. Cl. H04M 11/10

(52) U.S. Cl. 455/413; 455/519; 455/515

(57) ABSTRACT

A wireless message informing system is provided for use in a portable communication device and an announcing device. The wireless message informing system includes a local transmitting device and a remote receiving device. The local transmitting device and the remote receiving device are coupled together electromagnetically. The local transmitting device is configured in the portable communication device while the remote receiving device is coupled to the announcing device. When the local transmitting device receives a wireless signal, it outputs a triggering signal. After the remote receiving device receives the triggering signal, it feeds a driving signal into the announcing device so that the announcing device outputs an informing signal for notifying a user.

This application incorporates by reference Taiwanese application Serial No. 90110445, filed on May 1, 2001.

### BACKGROUND OF THE INVENTION

1. Field of the Invention

The invention relates in general to an apparatus for detecting wireless signals, and more particularly to a wireless message informing system.

2. Description of the Related Art

As the technology progresses, the high technology industrial has advanced as well, brining the people more convenient daily lives. In the early days, people mostly used telephones as the main communication facilities to connect people at a distance. Nowadays, it is thanks to well-developed mobile communication technology, mobile phones not only provide complete functionality, but also have reasonable prices. Thus, the mobile phones rapidly become widely-used articles in daily lives.

In the current mobile communication technology, the mobile phone is to perform positioning with micro-stations at intervals, making the micro-stations can position the mobile phone. Since the positioning signal for positioning is weak and the mobile phone will not ring on receiving it, the user is not easily aware that the mobile phone is performing positioning with the micro-station. On the other hand, when an incoming call is made, the micro-station first sends an incoming call signal, which has larger intensity than the positioning signal, to the mobile phone and the mobile phone rings to notify the user.

Nowadays, mobile phones provide complete functionality for the fulfilling the users' needs. For example, in places where it is inconvenient to listen to the mobile phone, the user can set the mobile phone in mute mode or vibration mode to prevent undesired telephone ring disturbing people around the user. If the user is afraid of losing important calls, a common solution is to use a mobile phone decoration with call detection, which flashes as a mobile phone call is detected. The principle of the mobile phone decoration with call detection is simple. First, the user puts the mobile phone decoration near the mobile phone. Since the mobile phone decoration is sensitive to incoming call signals, when it detects a incoming call signal, the circuit within it is then initiated to flash the light. In the design of the mobile phone decoration, it is naturally configured to flash the light according to the signal intensity of the received signal. In this way, when the mobile phone is doing positioning with the station, the mobile phone decoration does not flash due to the positioning signal is relatively weak. On the other hand, when the mobile phone decoration receives an incoming call signal, the mobile phone decoration is to flash due to the incoming call signal has greater intensity than the positioning signal has. As for a complex mobile phone with built-in incoming call informing function, it will not be described.

As described above, the mobile phone decoration with call detection is a feasible approach. However, it is inaccurate in some situations. For example, if there is another mobile phone of user B near user A with a mobile phone decoration, user A may be erroneously notified by the flashing of the mobile phone decoration as an incoming call signal for the another mobile phone of user B is received by the mobile phone decoration of user A. The mobile phone decoration is to be initiated merely according to the signal intensity. In another situation, if the user does not have the mobile phone at the user's side, the user may not be notified as an incoming call is being received by the mobile phone. For example, if the user is using computer in the a room and has her mobile phone left in the living room, she may lose an incoming call as she concentrates on watching the display monitor of the computer.

### SUMMARY OF THE INVENTION

It is therefore an object of the invention to provide a wireless message informing system. By the invention, when a portable communication device receives a wireless signal, a remotely located announcing device is triggered. In this way, the user is informed and would not lose the opportunity to respond to an incoming message.

According to the object of the invention, it provides a wireless message informing system, for use in a portable communication device and an announcing device. The wireless message informing system includes a local transmitting device and a remote receiving device. The local transmitting device and the remote receiving device are coupled together electromagnetically. The local transmitting device is configured in the portable communication device while the remote receiving device is coupled to the announcing device. When the local transmitting device receives a wireless signal, it outputs a triggering signal. After the remote receiving device receives the triggering signal, it feeds a driving signal into the announcing device so that the announcing device outputs an informing signal for notifying a user. The local transmitting device includes an induction power supply and a transmitting device coupled to the induction power supply. On receiving the wireless signal, the induction power supply provides an electric power for the transmitting device to operate so that the transmitting device outputs the triggering signal. In addition, the transmitting device includes a frequency adjusting device and a transmitter. The frequency adjusting device is used for adjusting the frequency of the triggering signal so that the triggering signal of the user can be distinguished from the other user. It is certain that the frequency of the triggering signal of the local transmitting device must correspond to that of the associated remote receiving device. In this way, the remote receiving device includes a frequency adjusting device and a receiver. The frequency adjusting device, coupled to the receiver, is used for adjusting the frequency characteristics of the receiver. Thus, the frequency characteristics of the receiver can be identical to the triggering signal. When the receiver receives the triggering signal, the triggering signal is outputted to the announcing device so that the announcing device outputs the informing signal to notify the user.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1A illustrates the operation of a wireless message informing system according to a preferred embodiment of the invention;

FIG. 1B is a block diagram illustrating the wireless message informing system according to a preferred embodiment of the invention;

FIG. 2 shows a block diagram of the local transmitting device in FIG. 1B;

FIG. 3 shows a block diagram of the induction power supply in FIG. 2;

FIG. 4 shows a block diagram of the transmitting device in FIG. 2; and

FIG. 5 shows a block diagram of the remote receiving device in FIG. 1B.

### DESCRIPTION OF THE PREFERRED EMBODIMENT

By the principle of the invention, a wireless message informing system has a transmitter configured in a portable communication device such as a mobile phone and has a receiver configured in an announcing device such as a personal computer system, wherein the transmitter is coupled to the receiver electromagnetically. When the mobile phone receives a wireless signal, such as an incoming call, the transmitter transmits a triggering signal. After the receiver receives the triggering signal, the personal computer system outputs an announcing signal. For instance, the announcing signal is presented as an on screen display (OSD) or a sound produced, so as to notify the user. For the sake of simplicity, the following description will take the mobile phone as the portable communication device and the personal computer system as the announcing device because the mobile phone and the personal computer system are widely used.

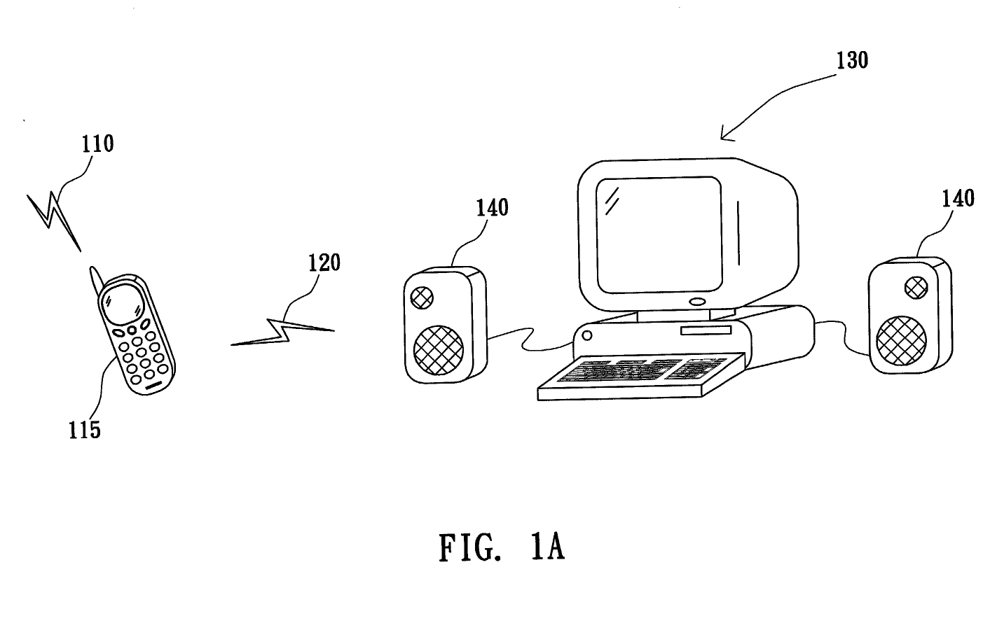

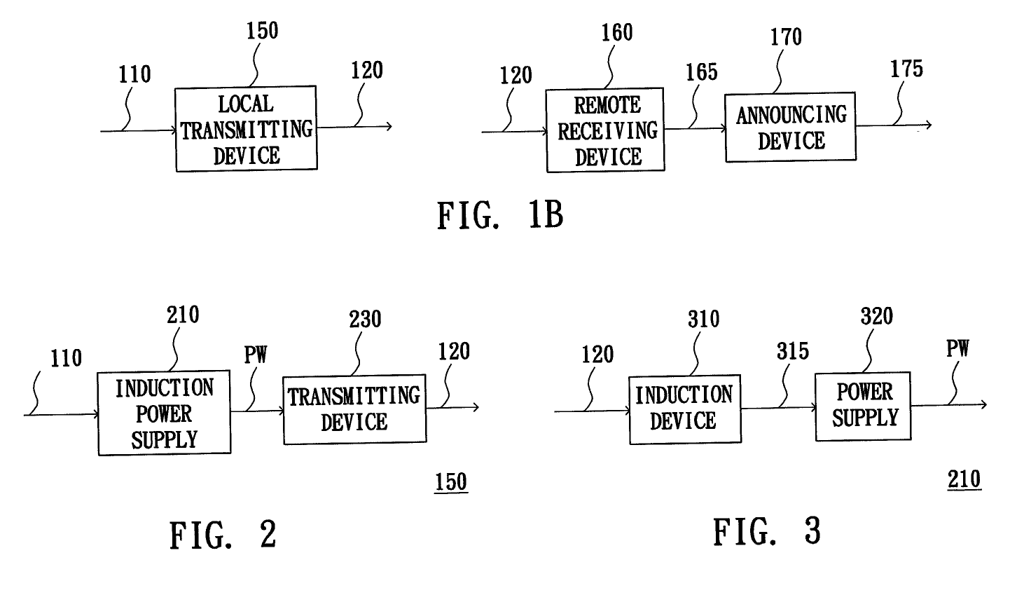

Referring to FIG. 1A, it illustrates the operation of a wireless message informing system according to a preferred embodiment of the invention. As an example of the operation, it is supposed that a user is working on the side of a personal computer 130 and has a mobile phone 115 put on the other room. In this case, when a wireless signal 110 is transmitted to the mobile phone 115, the local transmitting device (not shown) in the mobile phone 115 is to output a triggering signal 120. When the remote receiving device (not shown) in the personal computer 130 receives the triggering signal 120, an incoming call signal is to be displayed on the monitor of the personal computer 130, or a speaker 140 is to make a sound so as to notify the user. In this way, the user would not lose any incoming call even if the user does not hear the mobile phone ring.

Turning now to FIG. 1B, it shows a block diagram of the wireless message informing system according to the preferred embodiment of the invention. The wireless message informing system includes a local transmitting device 150 and a remote receiving device 160. The local transmitting device 150 is configured in the mobile phone 115 to output the triggering signal 120 when the wireless signal 110 is received. The remote receiving device 160 is electronically coupled to the announcing device 170, such as the personal computer 130. On receiving the triggering signal 120, the remote receiving device 160 outputs a driving signal 165 to the announcing device 170 so that the announcing device 170 outputs an informing signal 175 for notifying the user. For instance, the remote receiving device 160 can be configured in a display device, such as a graphics adapter, of the announcing device 170. When the remote receiving device 160 receives the triggering signal 120, the user can be notified of the incoming call by using an on screen display (OSD) signal on the display monitor. In addition, the OSD signal can be presented in the way as a pop-up window to make it more noticeable. For another instance, the remote receiving device 160 can be configured in an audio device, such as a sound card, of the announcing device 170. When the remote receiving device 160 receives the triggering signal 120, the announcing device 170 notifies the user of the incoming call by using the speaker to produce audio signals. As described above, the OSD signal displayed on the monitor or the audio signals produced by the speaker can be employed to notify the user so they can be used as the informing signal 175.

Referring to FIG. 2, it shows a block diagram of the local transmitting device 150 in FIG. 1B. The local transmitting device 150 includes an induction power supply 210 and a transmitting device 230 coupled to the induction power supply. When the induction power supply 210 receives the incoming call signal, electric power PW is fed into the transmitting device 230 to transmit the triggering signal 120. That is, the induction power supply 210 does not supply electric power PW to the transmitting device 230 until the mobile phone receives the wireless signal 110. In the case of not receiving the wireless signal 110, the transmitting device 230 cannot transmit the triggering signal 120. When the induction power supply 210 receives the wireless signal 110, the transmitting device 230 obtains electric power to transmit the triggering signal 120. Thus, the triggering signal 120 is transmitted only if the wireless signal 110 is received by the mobile phone. Referring now to FIG. 3, it shows a block diagram of the induction power supply 210 in FIG. 2. The induction power supply 210 includes an induction device 310 and a power supply 320. After the induction device 310 receives the incoming call signal 120, an induction signal 315 can be fed into the power supply 320 so that the power supply 320 outputs electric power PW according to the induction signal 315. For example, the induction device 310 can be an induction coil while the induction signal 315 can be an induced current. When the induction coil receives the incoming call signal 120, a large induced current is produced by induction so as to turn on the power supply 320, providing electric power PW for the transmitting device 230 to operate.

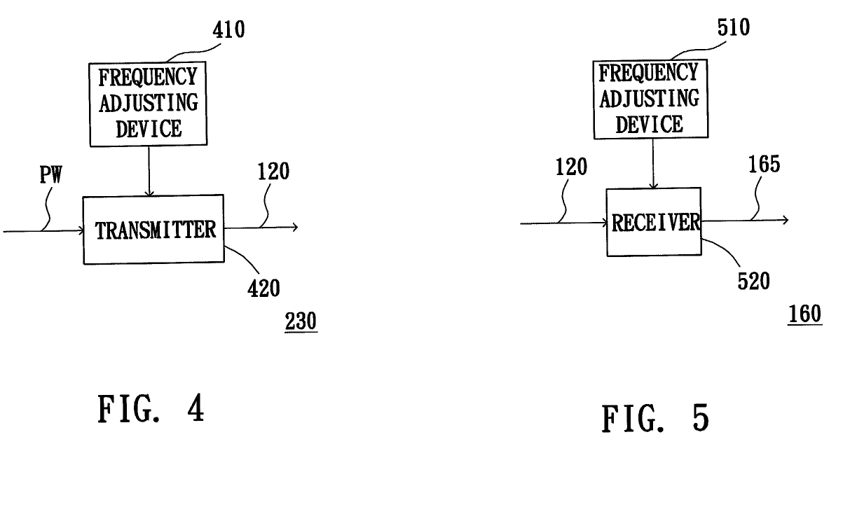

Further, when two or more local transmitting devices are to be used locally, the interference between the local transmitting devices can be avoided by adjusting frequencies of the associated triggering signals respectively so that the frequencies are differentiable. For example, in an office, users U1 and U2 are using the wireless message informing system, wherein user U1 uses mobile phone a while user U2 uses mobile phone b. In this case, the frequencies of the triggering signals associated with the wireless message informing system can be set to different values A and B respectively. Since the two frequencies of the triggering signals are different from each other, when mobile phone a has an incoming call, only the wireless message informing system for user U1 responds. Similarly, when mobile phone b has an incoming call, only the wireless message informing system for user U2 responds. In this way, the problem of incapable of signal identification for a plurality of users can be prevented. Referring now FIG. 4, it shows a block diagram of the transmitting device 230 in FIG. 2. The transmitting device 230 includes a frequency adjusting device 410 and a transmitter 420. The frequency adjusting device 410 is capable of adjusting the frequency of the triggering signal 120 in the transmitter 420 so that signals for different users of the wireless message informing system can be differentiable. It is certain that the frequency of the triggering signal of the local transmitting device must correspond to that of the associated remote receiving device; otherwise, the triggering signal will fail to be received by the associated remote receiving device. Referring now to FIG. 5, it shows a block diagram of the remote receiving device 160 in FIG. 1B. The remote receiving device 160 includes a frequency adjusting device 510 and a receiver 520. The frequency adjusting device 510 is used for adjusting the frequency characteristics of the receiver 520 so that the frequency of the receiver 520 matches the frequency of the triggering signal. When the receiver 520 receives the triggering signal 120, the driving signal 165 is outputted to the announcing device 170, the announcing device 170 then outputs the informing signal 175 so that the user is to be notified.

As disclosed above, the wireless message informing system according to the invention has the following advantages.

1. The informing signals for users are differentiable so that the users can be notified of the status of the incoming messages correctly.

2. Once the portable communication device receives the wireless signal, the announcing device is remotely triggered, avoiding losing the latest incoming message.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless message informing system, for use in a portable communication device and an announcing device, the wireless message informing system comprising:
a local transmitting device configured, in the portable communication device, to output a triggering signal according to a wireless signal; and
a remote receiving device electronically coupled to the announcing device and electromagnetically coupled to the local transmitting device, for receiving the triggering signal and, according to the triggering signal, feeding a driving signal into the announcing device so that the announcing device outputs an informing signal.

2. A wireless message informing system according to claim 1, wherein the triggering signal is frequency adjustable.

3. A wireless message informing system according to claim 1, wherein the local transmitting device comprises:
an induction power supply; and
a transmitting device coupled to the induction power supply;
wherein, according to the wireless signal, the induction power supply provides an electric power for the transmitting device to operate so that the transmitting device outputs the triggering signal.

4. A wireless message informing system according to claim 3, wherein the induction power supply comprises:
an induction device for outputting an induction signal according to the wireless signal; and
a power supply, coupled to the induction device, for providing, according to the induction signal, the electric power for the transmitting device to operate.

5. A wireless message informing system according to claim 4, wherein the induction device is an induction coil.

6. A wireless message informing system according to claim 3, wherein the transmitting device comprises:
a frequency adjusting device for adjusting the frequency of the triggering signal; and
a transmitter coupled to the frequency adjusting device for outputting the triggering signal after adjustment by the frequency adjusting device.

7. A wireless message informing system according to claim 3, wherein the portable communication device is a mobile phone.

8. A wireless message informing system according to claim 7, wherein the wireless signal indicates an incoming call.

9. A wireless message informing system according to claim 3, wherein the announcing device is a personal computer system.

10. A wireless message informing system according to claim 9, wherein the remote receiving device is configured in a display device of the personal computer system.

11. A wireless message informing system according to claim 10, wherein the display device is a graphics adapter.

12. A wireless message informing system according to claim 10, wherein the informing signal is an on-screen display (OSD) signal.

13. A wireless message informing system according to claim 12, wherein the OSD signal is to be presented by a pop-up window.

14. A wireless message informing system according to claim 9, wherein the remote receiving device is configured in an audio device of the personal computer system.

15. A wireless message informing system according to claim 1, wherein the remote receiving device comprises:
a receiver for receiving the triggering signal and producing the driving signal according to the triggering signal; and
a frequency adjusting device, coupled to the receiver, for adjusting the frequency characteristics of the receiver.
